(19) United States
(12) Patent Application Publication
(10) Pub. No.: US 2019/0191927 A1
(43) Pub. Date: Jun. 27, 2019

(54) Grill Roller System

(71) Applicants: Thomas D. Diffely, Ryder, ND (US); Adrahl Neal Hendrickson, Williston, ND (US)

(72) Inventors: Thomas D. Diffely, Ryder, ND (US); Adrahl Neal Hendrickson, Williston, ND (US)

(21) Appl. No.: 15/853,546

(22) Filed: Dec. 22, 2017

(51) Int. Cl. A47J 37/04; A47J 37/07

(52) U.S. Cl. CPC A47J 37/048; A47J 2037/0795; A47J 37/0745

(57) ABSTRACT

A grill roller system which is elevated with respect to a grilling surface and which may be freely swung between multiple positions. The grill roller system generally includes a base which is positioned or connected to a grill. A frame is pivotally connected to the base such that the frame may swing, pivot, or rotate between a plurality of positions including a first position which covers the grilling surface and a second position which exposes the grilling surface. A plurality of rollers on the frame may be utilized to rotate and evenly cook cylindrical food items such as hot dogs while other food items such as steaks are simultaneously cooking on the underlying grill surface. The system may also include a rotator assembly for automatically or manually rotating the rollers.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a grill roller system which is elevated with respect to a grilling surface and which may be freely swung between multiple positions.

### Related Art

Any discussion of the related art throughout the specification should in no way be considered as an admission that such related art is widely known or forms part of common general knowledge in the field.

Rollers are commonly used to cook hot dogs or other cylindrical food items. Generally, a roller will have its own heating element and thus comes packaged as a standalone unit. Where rollers have been connected to grills, they have done so in a manner which renders a large grilling surface of the grill unusable so that other food items may not be simultaneously cooked with the food items on the rollers.

### SUMMARY

An example embodiment of the present invention is directed to a grill roller system. The grill roller system includes a base which is positioned or connected to a grill. A frame is pivotally connected to the base such that the frame may swing, pivot, or rotate between a plurality of positions including a first position which covers the grilling surface and a second position which exposes the grilling surface. A plurality of rollers on the frame may be utilized to rotate and evenly cook cylindrical food items such as hot dogs while other food items such as steaks are simultaneously cooking on the underlying grill surface. The system may also include a rotator assembly for automatically or manually rotating the rollers.

There has thus been outlined, rather broadly, some of the features of the grill roller system in order that the detailed description thereof may be better understood, and in order that the present contribution to the art may be better appreciated. There are additional features of the grill roller system that will be described hereinafter and that will form the subject matter of the claims appended hereto. In this respect, before explaining at least one embodiment of the grill roller system in detail, it is to be understood that the grill roller system is not limited in its application to the details of construction or to the arrangements of the components set forth in the following description or illustrated in the drawings. The grill roller system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a grill roller system installed on a grill in accordance with an example embodiment.

FIG. 2a is a top view of a grill roller system with the frame in a first position in accordance with an example embodiment.

FIG. 2b is a top view of a grill roller system with the frame in a second position in accordance with an example embodiment.

FIG. 3 is a frontal perspective view of a grill roller system in accordance with an example embodiment which utilizes a first rotator assembly.

FIG. 4 is a rear perspective view of a grill roller system in accordance with an example embodiment which utilizes a first rotator assembly.

FIG. 5 is a top view of a grill roller system with the frame in a first position in accordance with an example embodiment which utilizes a first rotator assembly.

FIG. 6 is a frontal perspective view of a grill roller system with the frame in a second position in accordance with an example embodiment which utilizes a first rotator assembly.

FIG. 7 is a bottom view of a grill roller system in accordance with an example embodiment which utilizes a first rotator assembly.

FIG. 8 is a first side view of a grill roller system in accordance with an example embodiment which utilizes a first rotator assembly.

FIG. 9 is a first side view of a grill roller system in accordance with an example embodiment which utilizes a first rotator assembly.

FIG. 10 is a rear view of a grill roller system in accordance with an example embodiment which utilizes a first rotator assembly.

FIG. 11 is a frontal view of a grill roller system in accordance with an example embodiment which utilizes a first rotator assembly.

FIG. 12 is an exploded perspective view of a grill roller system in accordance with an example embodiment which utilizes a first rotator assembly.

FIG. 13 is a frontal perspective view of a grill roller system in accordance with an example embodiment which utilizes a second rotator assembly.

FIG. 14 is a rear perspective view of a grill roller system in accordance with an example embodiment which utilizes a second rotator assembly.

FIG. 15 is a top view of a grill roller system with the frame in a first position in accordance with an example embodiment which utilizes a second rotator assembly.

FIG. 16 is a frontal perspective view of a grill roller system with the frame in a second position in accordance with an example embodiment which utilizes a second rotator assembly.

FIG. 17 is a bottom view of a grill roller system in accordance with an example embodiment which utilizes a second rotator assembly.

FIG. 18 is a first side view of a grill roller system in accordance with an example embodiment which utilizes a second rotator assembly.

FIG. 19 is a first side view of a grill roller system in accordance with an example embodiment which utilizes a second rotator assembly.

FIG. 20 is a rear view of a grill roller system in accordance with an example embodiment which utilizes a second rotator assembly.

FIG. 21 is a frontal view of a grill roller system in accordance with an example embodiment which utilizes a second rotator assembly.

FIG. 22 is an exploded perspective view of a grill roller system in accordance with an example embodiment which utilizes a second rotator assembly.

FIG. 23 is a frontal view of an exemplary gear for use as a roller gear or a rotator gear in accordance with an example embodiment which utilizes a second rotator assembly.

### DETAILED DESCRIPTION

### A. Overview.

An example grill roller system 10 generally comprises a base 20 which is positioned or connected to a grill 12. A frame 30 is pivotally connected to the base 20 such that the frame 30 may swing, pivot, or rotate between a plurality of positions including a first position which covers the grilling surface 13 and a second position which exposes the grilling surface 13. A plurality of rollers 40 on the frame 30 may be utilized to rotate and evenly cook cylindrical food items 14 such as hot dogs while other food items 14 such as steaks are simultaneously cooking on the underlying grill surface 13. The system 10 may also include a rotator assembly 50, 60 for automatically or manually rotating the rollers 40.

### B. Base.

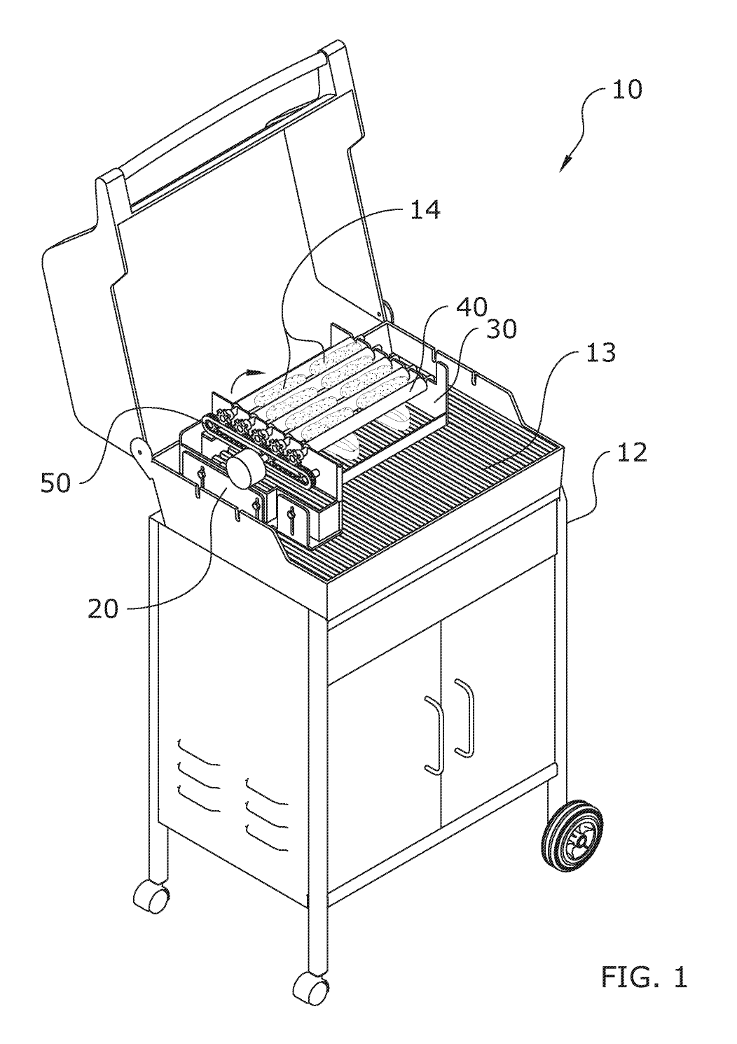

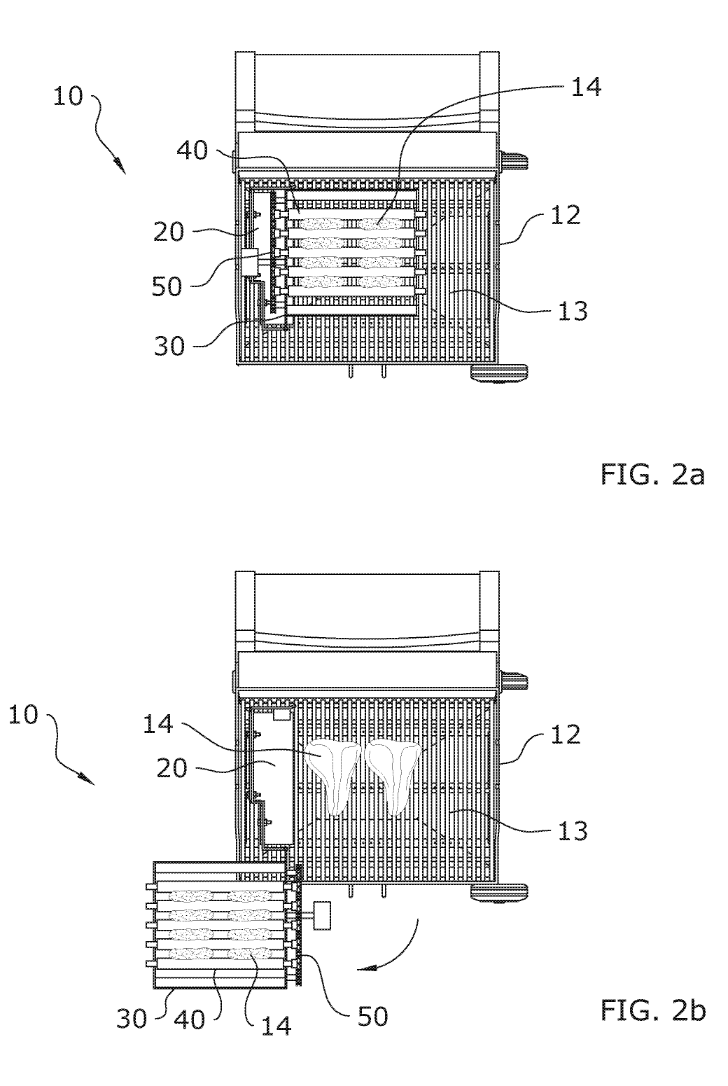

As shown in FIGS. 1, 2a, and 2b, a base 20 is removably positioned on or connected to the grill 12. The base 20 may be secured to the grill 12, such as by securing the base 20 to a sidewall of the grill 12 or by securing the base 20 to the grilling surface 13 itself. The base 20 may also be free-standing on the grilling surface 13. The manner in which the base 20 is connected to the grill 12 and/or positioned on the grilling surface 13 may vary in different embodiments and should not be construed as limited by the exemplary figures.

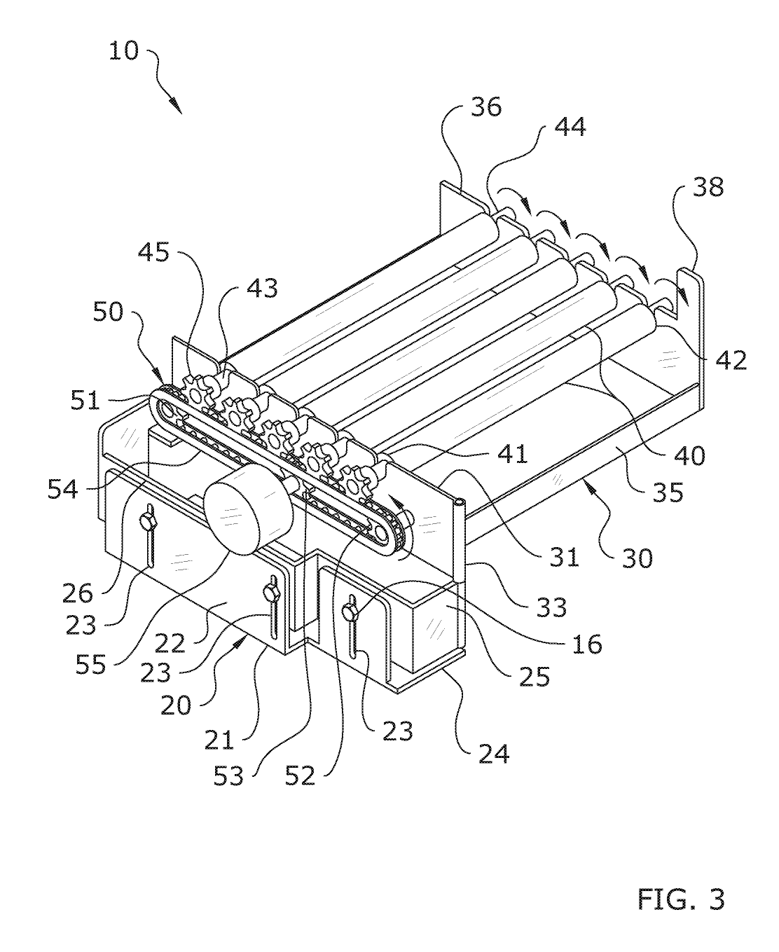

As shown in FIG. 3, the base 20 may comprise an outer support 21 and an inner support 25 adjustably connected to the outer support 21. The use of outer and inner supports 25 allows for adjustment of the base 20, such as adjusting its height. The outer support 21 may in some embodiments be connected to some portion of the grill 12, such as its sidewall, via brackets, clasps, fasteners, or the like. The inner support 25 is preferably slidably adjustable between multiple vertical positions with respect to the outer support 21 such that the base 20 is height-adjustable.

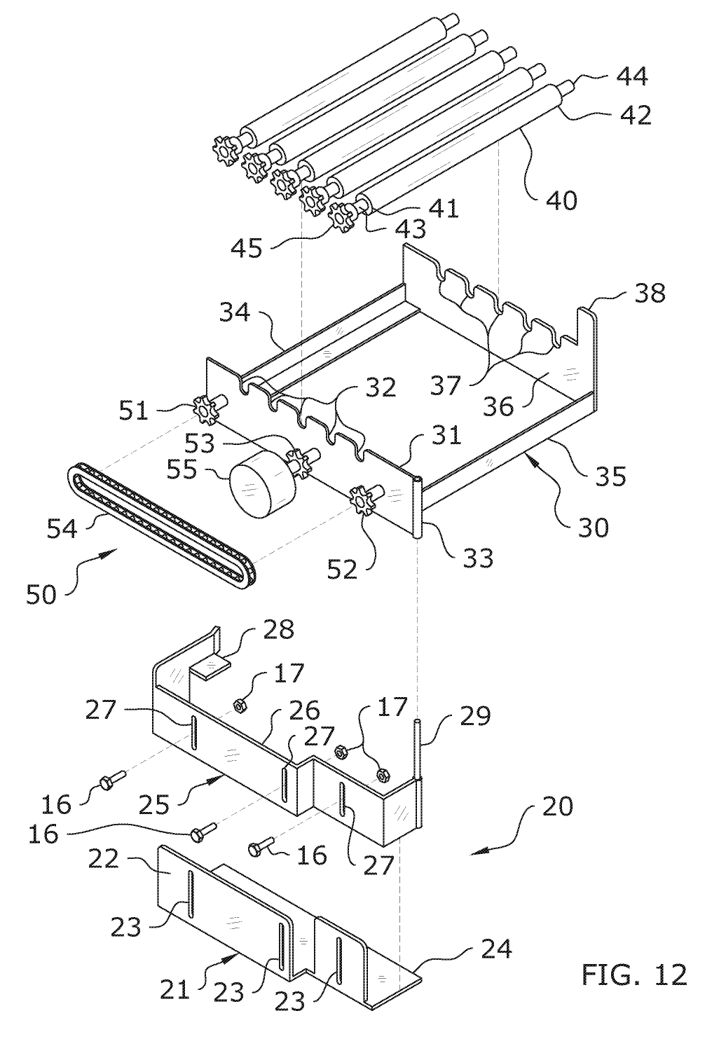

As best shown in FIG. 12, the outer support 21 may comprise an L-shaped configuration in which one or more first connectors 22 extend vertically and a horizontal extension 24 extends horizontally from the lower end of the first connectors 22. In the exemplary embodiment of the figures, the first connectors 22 comprise vertical walls which include first openings 23. The first openings 23 may comprise elongated openings such as slots which extend vertically on the outer support 21. These first openings 23 are utilized in conjunction with corresponding second openings 27 on the inner support 25 to adjust the base 20 as discussed herein.

The inner support 25 is removably and adjustably connected to the outer support 21. The inner support 25 may comprise an elongated member with a generally U-shaped configuration as shown in FIG. 12. The inner support 25 may include second connectors 26 which are removably connected to the first connectors 22 of the outer support 21. The second connectors 26 may comprise vertical walls which include second openings 27. The second openings 27 may comprise elongated openings such as slots which extend vertically on the inner support 25. The inner support 25 may also include a ledge 28 which supports the frame 30 when the frame 30 is positioned over the base 20 as discussed herein.

The outer and inner supports 21, 25 are interconnected so as to allow vertical adjustment of the height of the base 20. This height-adjustable functionality is provided primarily by the first and second openings 23, 27. The first openings 23 on the outer support 21 are aligned with the second openings 23, 27 on the inner support 25 such that the inner support 25 may be locked into various vertical positions with respect to the outer support 21. Fasteners 16 may be utilized to lock the base 20 at a certain height position by extending the fasteners 16 through both first and second openings 23, 27 and securing with nuts 17 such as shown throughout the figures.

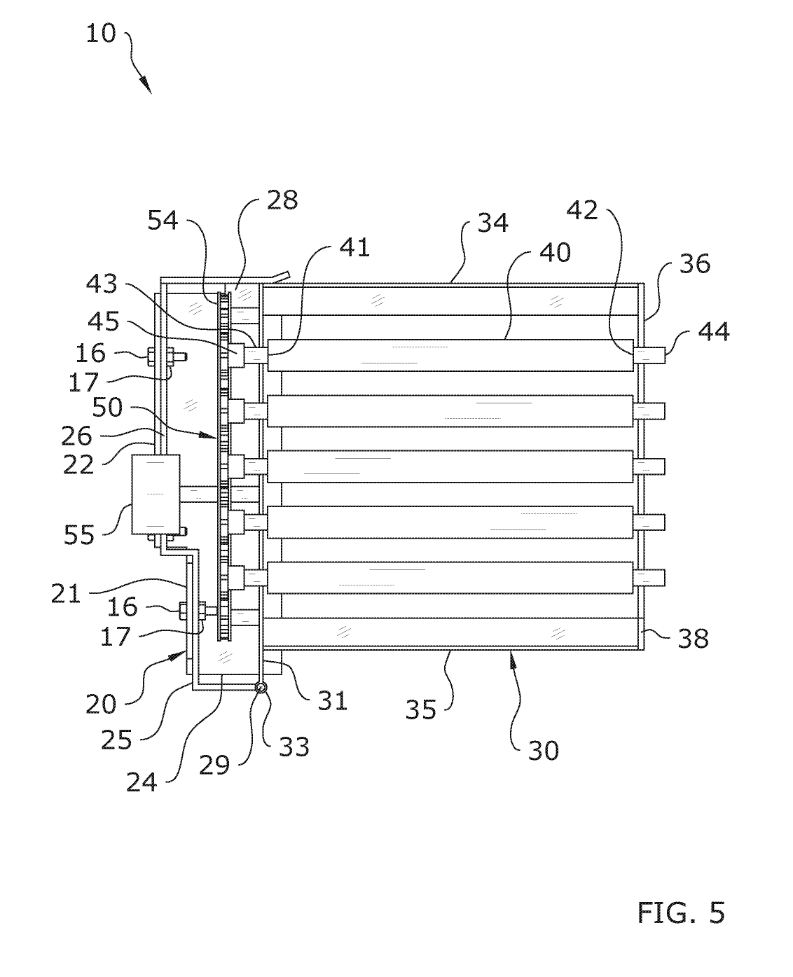

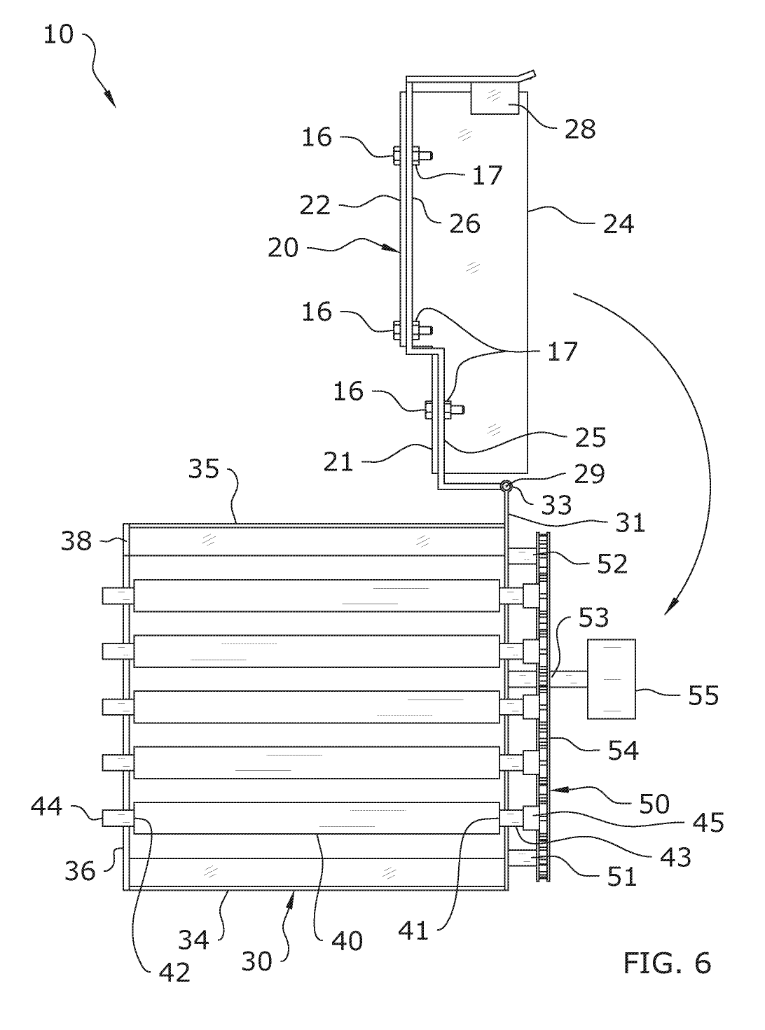

The base 20 may also include a first pivot connector 29 which is utilized to pivotally connect the frame 30 to the base 20. The first pivot connector 29 generally is pivotally connected to a second pivot connector 33 on the frame 30 such that the frame 30 may pivot with respect to the base 20. The frame 30 is preferably pivotally connected to the base 20 such that the frame 30 may swing outwardly or inwardly with respect to the base 20 as shown in FIGS. 5-6. The first pivot connector 29 is shown in FIG. 3 as extending upwardly from the horizontal extension 24 of the outer support 21 of the base 20.

Although the first pivot connector 29 is illustrated as comprising a pivot pin, it should be appreciated that in some embodiments the first pivot connector 29 may comprise a receiver, with the second pivot connector 29 instead comprising a pin. It should be appreciated that the first pivot connector 29 may be positioned at various locations along the base 20. Preferably, the first pivot connector 29 will be positioned at or near a corner of the base 20 to prevent restriction of the swinging radius of the frame 30 with respect to the base 20.

### C. Frame.

As shown throughout the figures, a frame 30 is pivotally connected to the base 20 such that the frame 30 may swing inwardly or outwardly with respect to the base 20. The frame 30 supports a plurality of rollers 40 which are adapted to support and rotate a plurality of food items 14 such as hot dogs. The frame 30 is preferably raised with respect to the grilling surface 13 by the base 20 such that food items 14 such as steaks or the like may be cooked on the grilling surface 13 underneath the frame 30 at the same time that other food items 14 are being cooked on the rollers 40 such as shown in FIGS. 1-3.

The frame 30 may comprise various constructions and should not be construed as limited in scope by the exemplary figures. In the exemplary figures, the frame 30 comprises a rectangular-shape having a frontal support 31, a first side support 34, a second side support 35, and a rear support 36. The frontal support 31 may include first indentations 22 and the rear support 36 may include second indentations 37 such as shown in FIG. 12. The rollers 40 are rotatably connected to the frame 30 between its frontal and rear supports 31, 36 by being rotatably positioned within the first and second indentations 22, 37 such as shown in FIG. 3.

The frame 30 generally include a second pivot connector 33 as shown in FIG. 12 which interconnects with the first pivot connector 29 on the base 20 to pivotally interconnect the frame 30 and base 20. The second pivot connector 33 may comprise a cylindrical receiver as shown in the figures which is adapted to receive the corresponding first pivot connector 29 on the base 20. When the first pivot connector 29 is inserted within the second pivot connector 33, the second pivot connector 33 may rotate with respect to the first pivot connector 29. It should be appreciated that, in some embodiments, the reverse configuration may be utilized: the first pivot connector 29 may comprise a receiver and the second pivot connector 33 may comprise a pin or the like.

The frame 30 may also include a pivot handle 38 which may be grasped by the user to lift and pivot the frame 30 with respect to the base 20. The pivot handle 38 may be positioned at various locations on the frame 30 and thus should not be construed as limited in scope by the positioning shown in the exemplary figures.

In the exemplary figures, the pivot handle 38 is shown as extending from the rear support 38 of the frame 30. Other locations may be utilized. The pivot handle 38 may comprise a vertical extension as shown in the figures or may extend horizontally or angularly with respect to the frame 30.

### D. Rollers.

As shown throughout the figures, the frame 30 may include a plurality of parallel rollers 40 which extend between the frontal support 31 and the rear support 36 of the frame 30 such as shown in FIGS. 5 and 6. The spacing, positioning, orientation, and number of rollers 40 may vary in different embodiments. Thus, the exemplary configuration shown in the figures should not be construed as limiting on the scope.

In the exemplary embodiment shown, each roller 40 comprises an elongated cylindrical rod or the like which is adapted to rotate within the frame 30. Food items 14 such as hot dogs may be placed in between adjacent rollers 40 such that the rollers 40 rotate the hot dogs as the rollers 40 are rotated by the rotator assemblies 50, 60.

As shown in the figures, each roller 40 includes a first end 41 and a second end 42. The first end 41 of each roller 40 is positioned in one of the first indentations 32 of the frontal support 31 of the frame 30. The second end 42 of each roller 40 is positioned in one of the second indentations 37 of the rear support 36 of the frame 30.

As best shown in FIG. 12, each roller 40 may include a first mount portion 43 at its first end 41 and a second mount portion 44 at its second end 42. The mount portions 43, 44 may be of a smaller diameter than the rest of the rollers 40. The mount portions 43, 44 fit within the indentations 32, 37 of the frame 30 and rotate therein to allow rotation of the rollers 40 within the frame 30 to evenly cook any food items 14 positioned on or between the rollers 40.

As shown in FIG. 12, each roller 40 may include a roller gear 45. In the exemplary figures, each roller 40 includes a roller gear 45 at its first end 41, though the roller gear 45 could be at the second end 42 of each roller 40 in some embodiments. The roller gear 45 interacts with the rotator assembly 50, 60 to transfer rotational force from the rotator assembly 50, 60 to the roller 40 as described in more detail below.

In some embodiments, the rollers 40 may each be individually removable. In this manner, the overall size of the present invention may be altered to meet different needs. Additionally, if one of the rollers 40 becomes damaged or needs maintenance/repair, the remaining rollers 40 may be retained for use while the broken roller 40 is serviced.

### E. Rotator Assemblies.

As shown throughout the figures, a rotator assembly 50, 60 is provided which imparts rotational force to each of the rollers 40 so that the rollers 40 rotate with respect to the frame 30. Various types of rotator assemblies 50, 60 may be utilized, and what follows should be considered an illustrative description of exemplary embodiments. The scope of the present invention should not be construed as limited to either of the two rotator assembly 50, 60 embodiments described or shown herein.

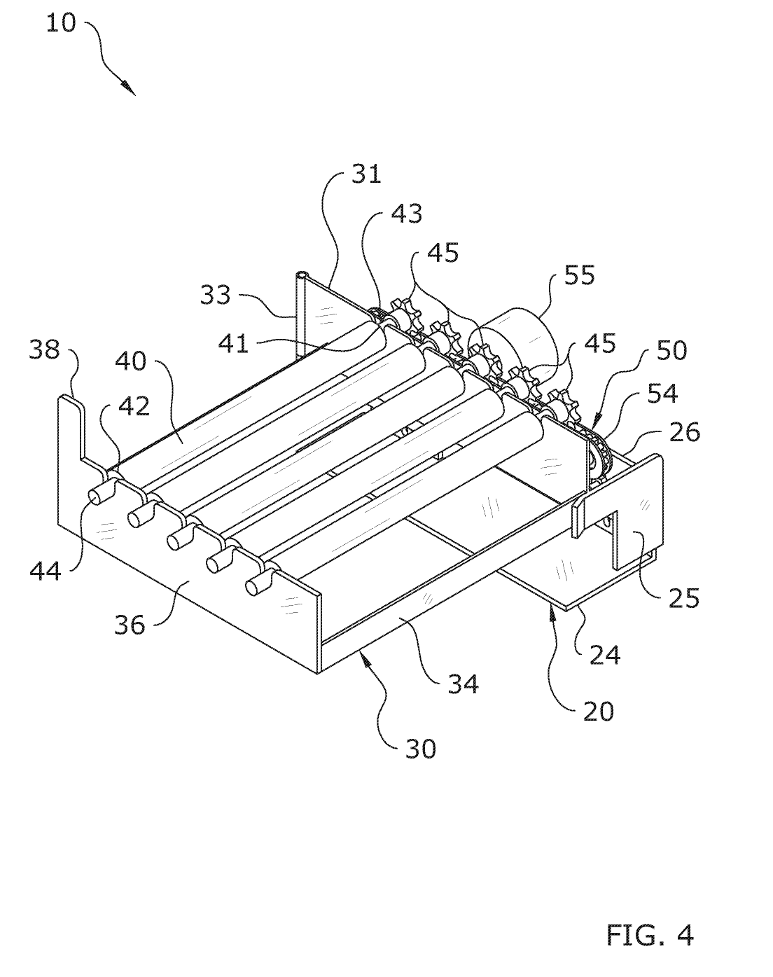

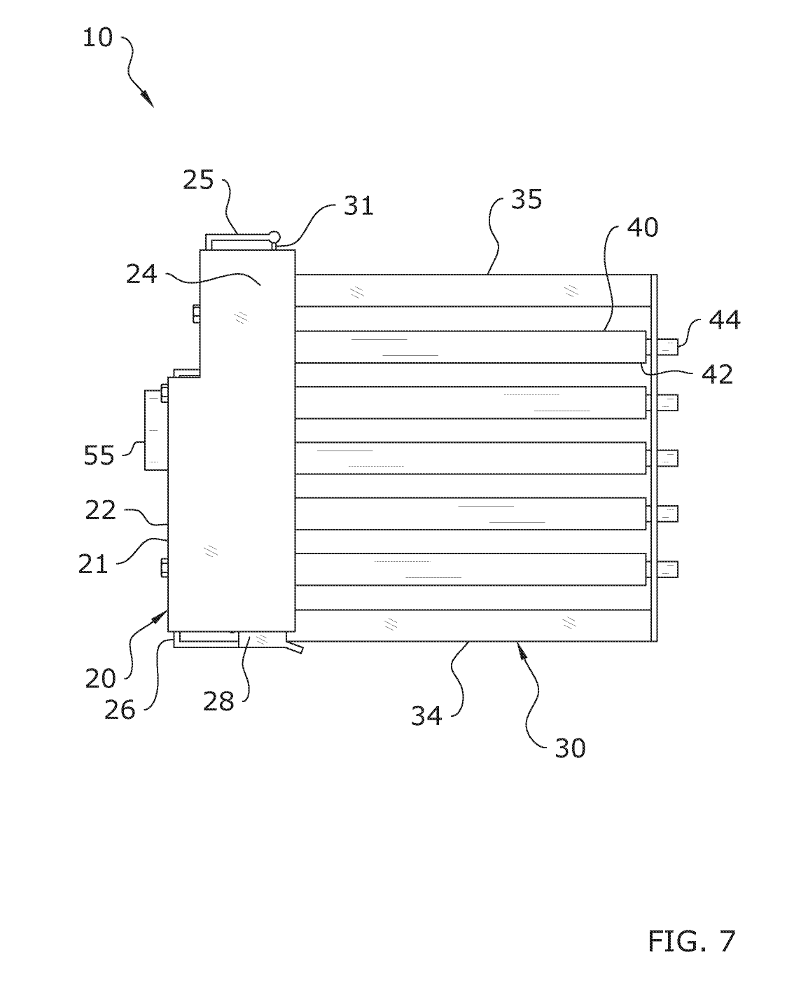

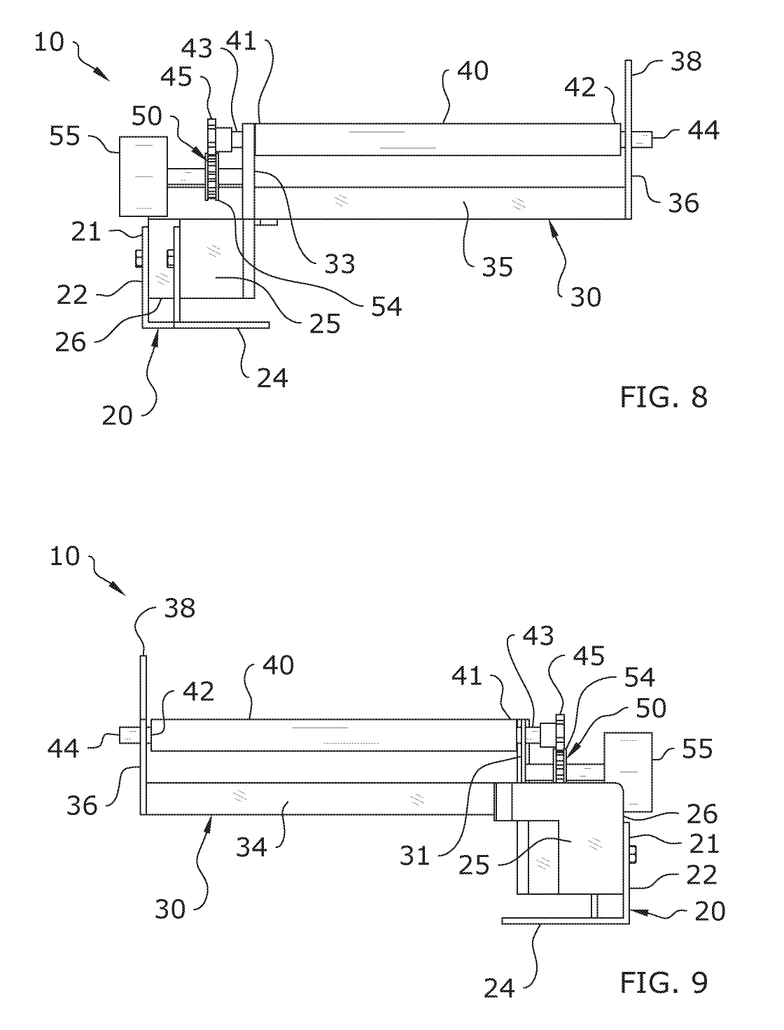

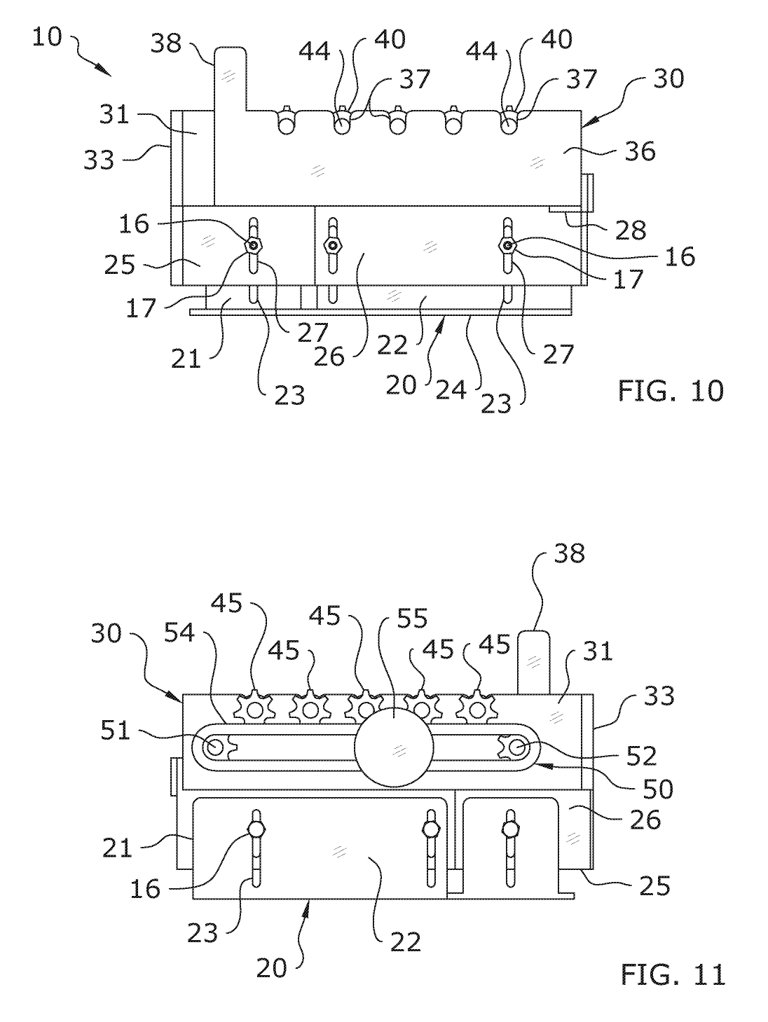

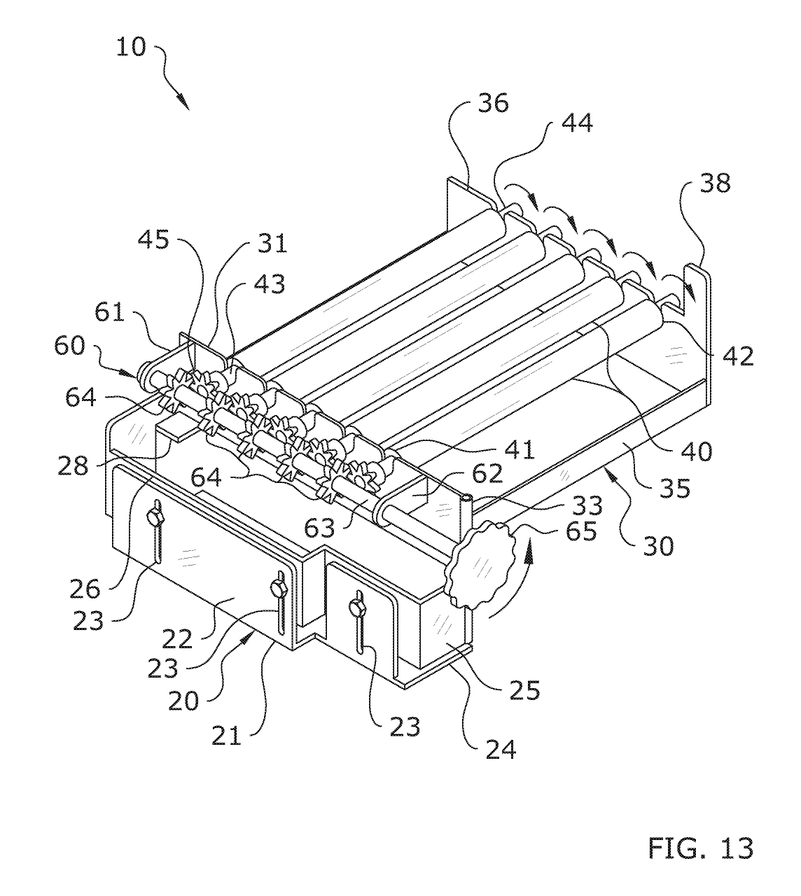

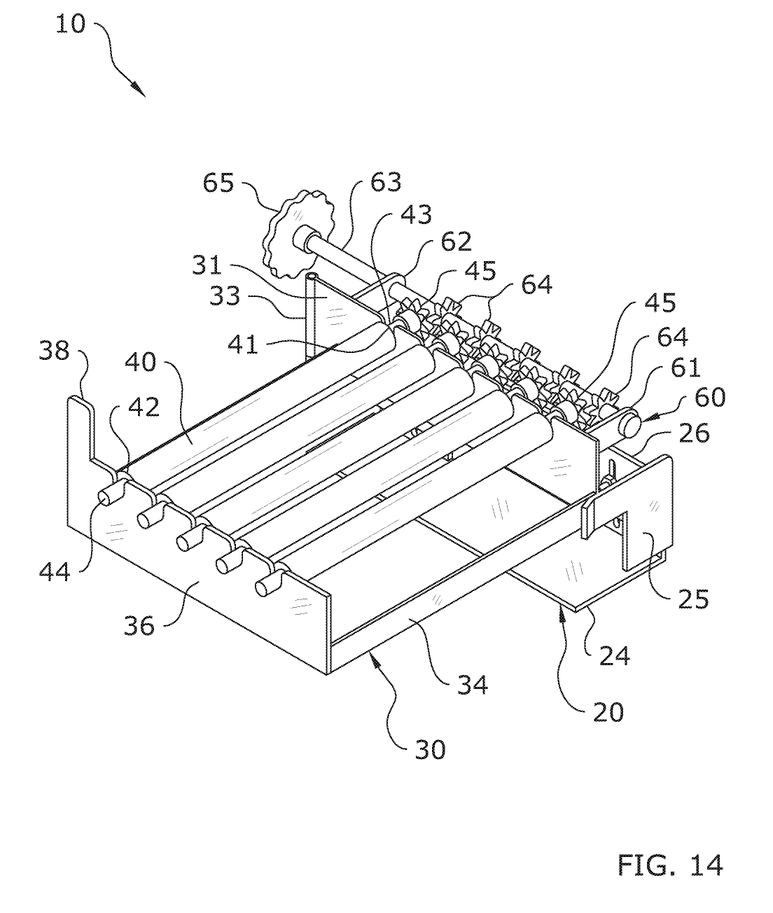

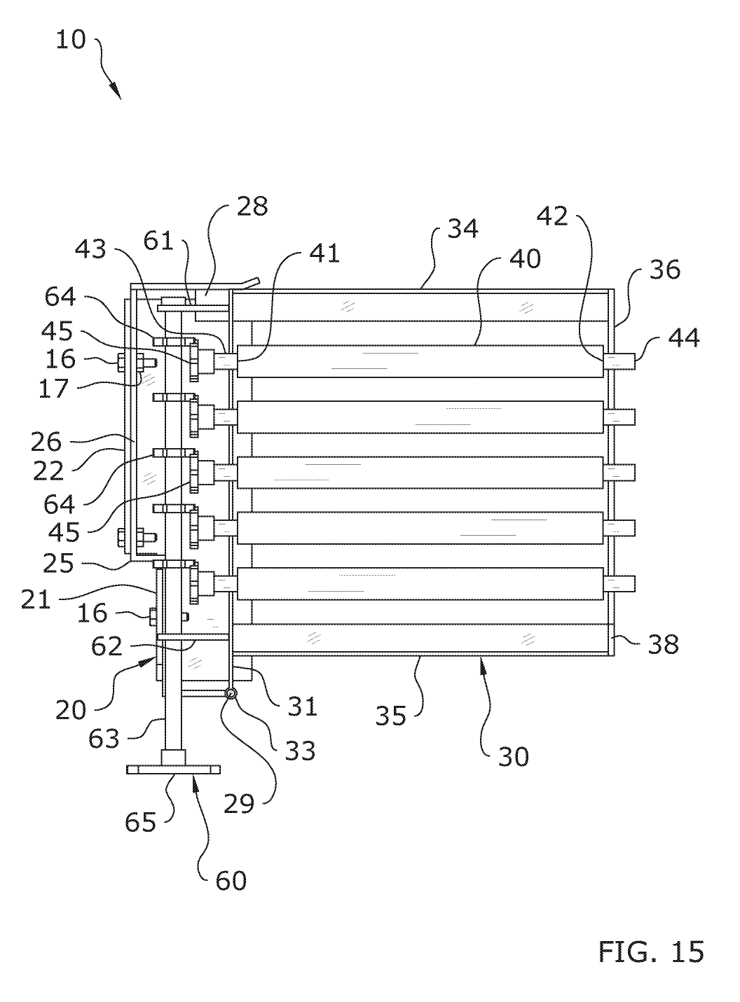

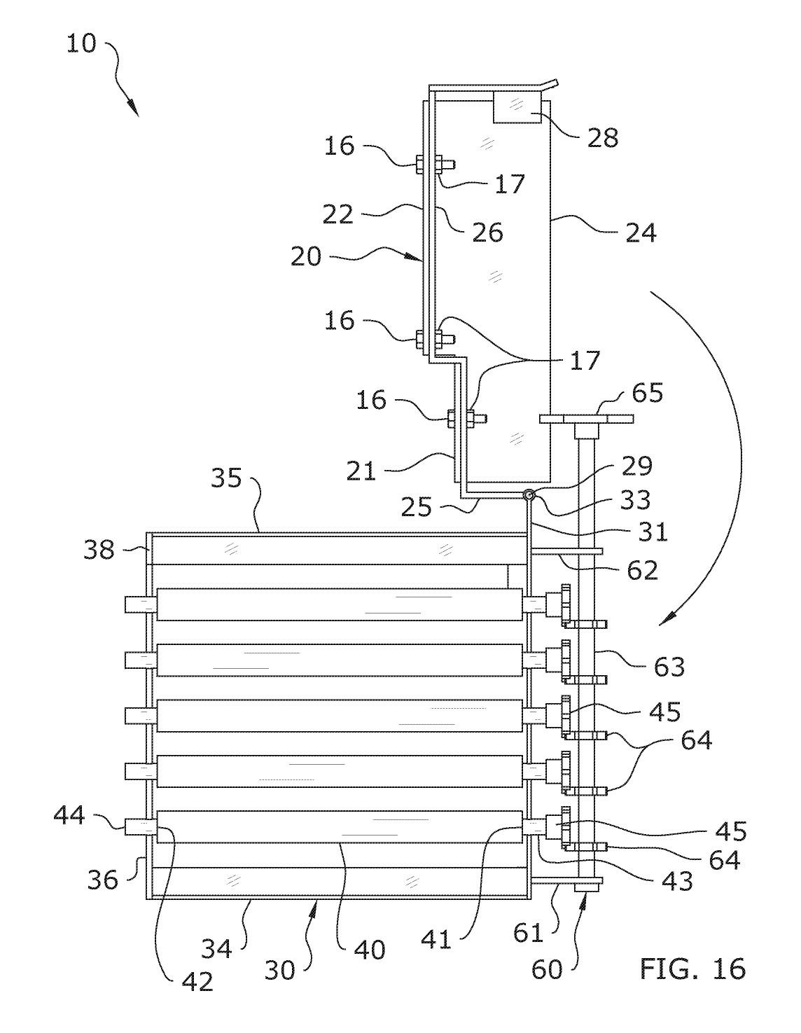

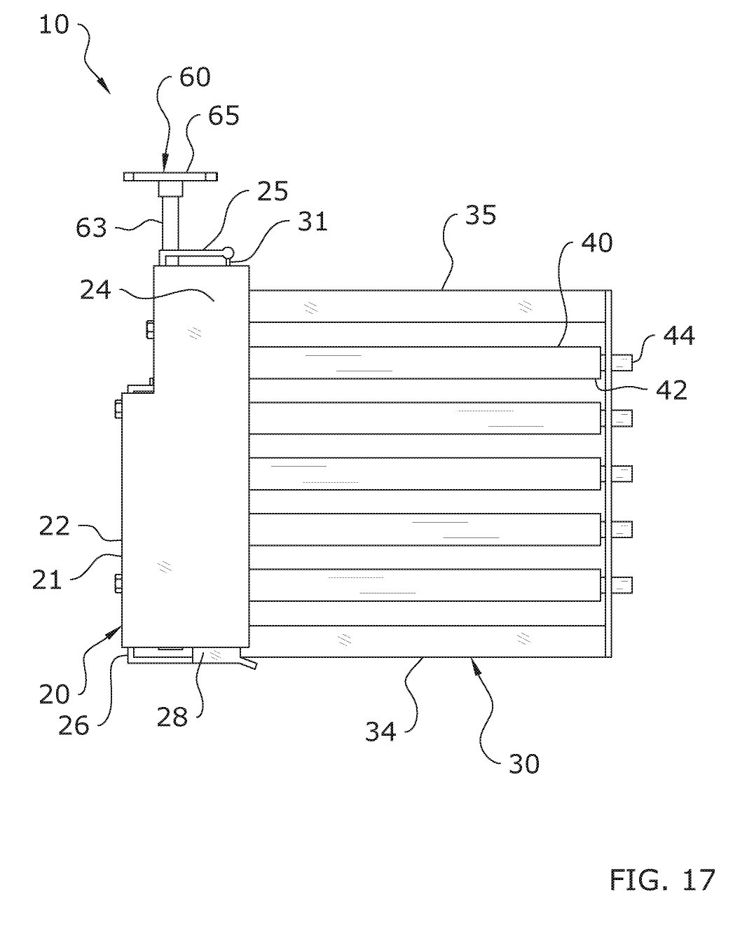

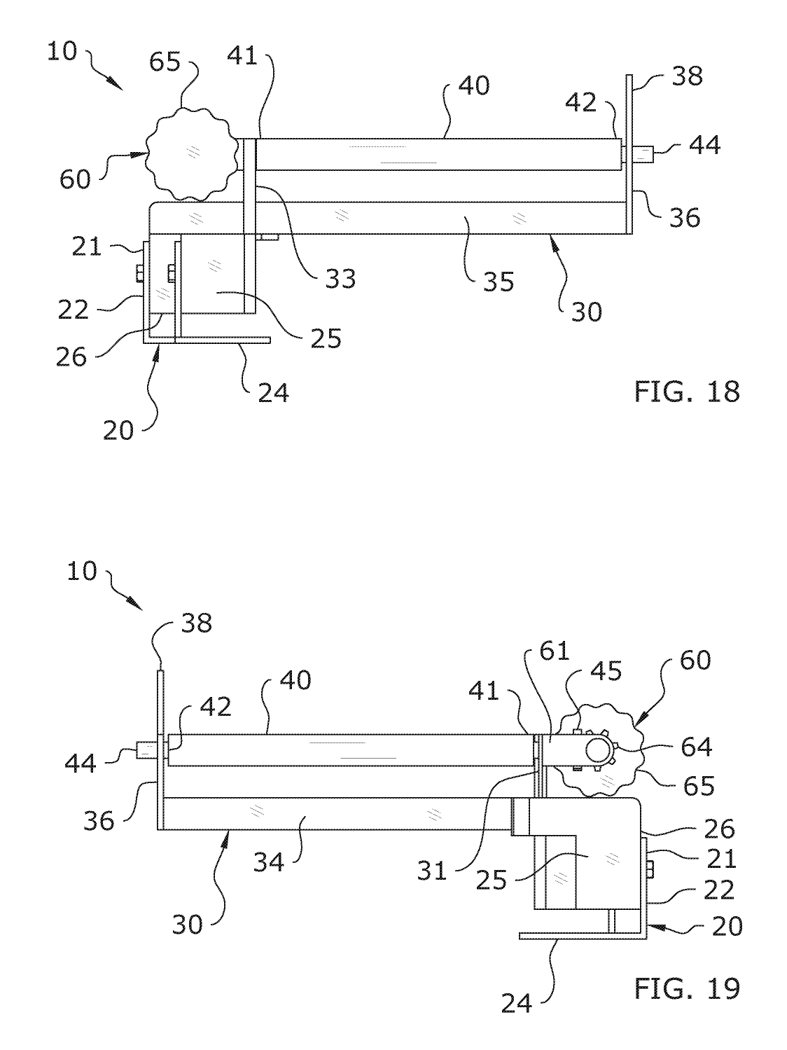

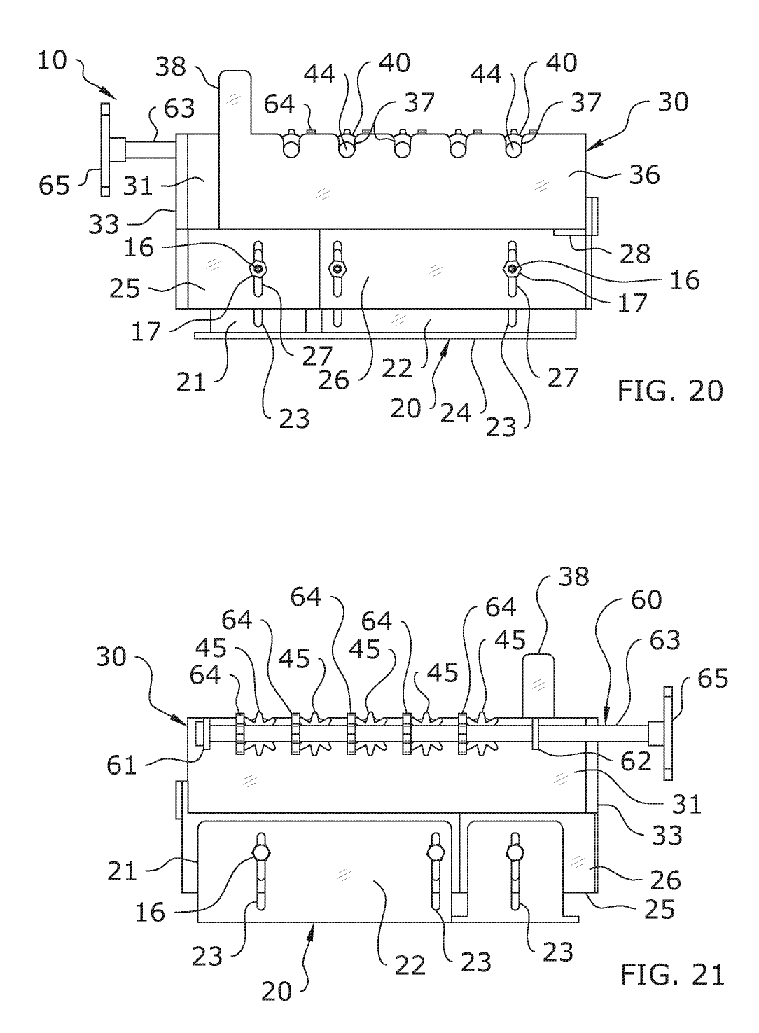

The figures illustrate two exemplary rotator assembly 50, 60 embodiments—a first rotator assembly 50 which is adjusted by a motor 55 and a second rotator assembly 60 which is rotated by hand. The first rotator assembly 50 is shown in FIGS. 1-12 and the second rotator assembly 60 is shown in FIGS. 13-22.

i. First Rotator Assembly.

As shown in FIGS. 1-12, the first rotator assembly 50 utilizes a motor 55 to rotate the rollers 40. One exemplary embodiment for the first rotator assembly 50 comprises a plurality of rotator gears 51, 52, 53 which are rotationally linked by a linkage 54 such as a chain. The rotator gears 51, 52, 53 may comprise sprockets, gears, or the like. The motor 55 directly rotates one of the rotator gears 51, 52, 53, with the remaining rotator gears 51, 52, 53 being indirectly rotated by the linkage 54. In some embodiments, the linkage 54 may be weighted to improve tension, such as by securing one or more weights to the bottom end of the linkage 54.

In an exemplary embodiment as shown in FIG. 3, the rotator gears 51, 52, 53 comprise a first outer rotator gear 51, a second outer rotator gear 52, and a central rotator gear 53. The central rotator gear 53 is illustrated as being directly connected to the motor 55 such that rotation of the motor's 55 drive shaft directly causes rotation of the central rotator gear 53. It should be appreciated that the motor 55 may alternately be connected to either of the other rotator gears 51, 52. In some embodiments, the motor 55 may be directly connected to multiple rotator gears 51, 52, 53.

The linkage 54 will preferably comprise a plurality of indentations or projections which interconnect with the roller gears 45 such as shown in FIG. 3. In the exemplary embodiment of FIG. 3, the linkage 54 comprises a chain having a plurality of chain links. The roller gears 45 engage with the linkage 54 such that, as the linkage 54 traverses its loop, the roller gears 45 are rotated by the passing linkage 54. The rotation of the roller gears 45 will directly cause the rotation of the respective rollers 40 to evenly cook the food item 14.

ii. Second Rotator Assembly.

FIGS. 13-22 illustrate a second rotator assembly 60 which may be utilized to manually rotate the rollers 40. A hand-rotated assembly 60 may be preferable for cooks who want to manually control the speed of rotation rather than relying upon the automation of a motor 55. The second rotator assembly 60 utilizes a rotator handle 65 which is manually rotated to impart rotational force to the rollers 40.

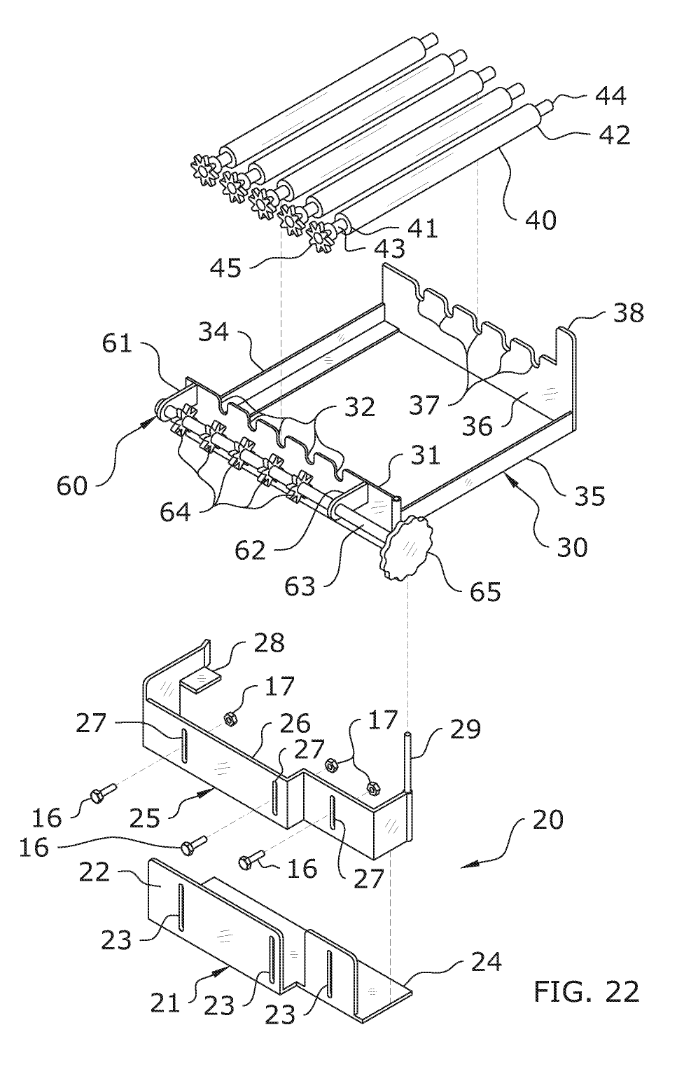

As best shown in FIG. 22, the second rotator assembly 60 comprises a pair of brackets 61, 62 which are connected to or integrally formed with the frame 30. In the exemplary embodiment of the figures, a first bracket 61 extends from a first side of the frontal support 31 and a second bracket 62 extends from a second side of the frontal support 31. A rotator rod 63 extends between and through the brackets 61, 62 in a rotational manner such that the rotator rod 63 may rotate freely within the brackets 61, 62.

As best shown in FIGS. 13-16 and 22, a plurality of rotator gears 64 are positioned along the length of the rotator rod 63. The rotator gears 64 are connected to the rotator rod 63 such that the rotator gears 64 rotate with the rotator rod 63. Corresponding roller gears 45 on the rollers 40 interconnect with the rotator gears 64 such that rotational force from the rotator rod 63 is imparted to rotate the rollers 40.

In the embodiment shown in the figures, the rotator gears 64 are aligned with a longitudinal axis extending perpendicular to the rotator rod 63. The roller gears 45 are aligned with a latitudinal axis extending parallel to the rotator rod 63 such that the axes of rotation of the roller gears 45 and rotator gears 64 are perpendicular with respect to each other. In other words, the roller gears 45 rotate around a first rotational axis and the rotator gears 64 rotate around a second rotational axis, wherein the first and second rotational axes are perpendicular with respect to each other.

As best shown in FIG. 22, a rotator handle 65 is positioned on the distal end of the rotator rod 63. The rotator handle 65 may be manually rotated to impart rotational force through the rotator rod 63, rotator gears 64, and the roller gears 45 to rotate the rollers 40. In some embodiments, a motor 55 or other mechanized rotational device may be connected to automatically rotate the rotator rod 63 or the rotator handle 65. In the figures, the rotator handle 65 is illustrated as comprises a circular configuration, though other configurations may be utilized.

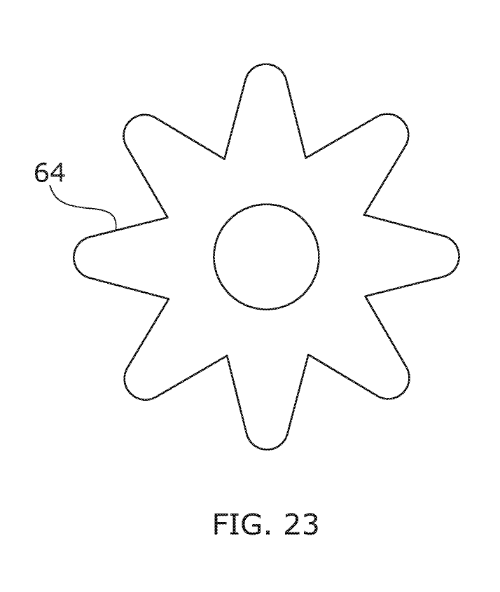

FIG. 23 illustrates a gear configuration which may be utilized for the roller gears 45 and the rotator gears 64. It should be appreciated that the exemplary figures and descriptions herein are merely exemplary with respect to the type of gear configuration, including shape and size, used for the roller or rotator gears 45, 64. Thus, the gears 45, 64 should not be construed as limited in scope as to shape, size, or configuration by the exemplary figures.

### F. Operation of Preferred Embodiment.

In use, the base 20 is first positioned on the grilling surface 13. The base 20 may be connected to the grill 12 directly, such as by connecting to the sidewall of the grill 12, or it may rest upon the grilling surface 13. In some embodiments, the base 20 may be connected directly to the grilling surface 13.

With the base 20 positioned on the grilling surface 13, the height of the frame 30 may be adjusted. The inner support 25 of the base 20 may be adjusted with respect to the outer support 21 to the desired height and then locked in place with fasteners 16 and nuts 17 extending through the respective openings 23, 27 on the outer and inner supports 21, 25. Adjustment of the effective height of the frame 30 by manipulation of the base 20 may be desirable to accommodate various different food items 14 to be cooked on the grilling surface 13 directly beneath the frame 30 when the frame 30 is in its first position such as shown in FIG. 2a.

With the base 20 positioned on the grill 12 and the effective height of the frame 30 adjusted, food items 14 may be positioned on the rollers 40 and/or the grilling surface 13 directly underneath the frame 30. To cook a food item 14 underneath the frame 30, the frame 30 may be swung into a second position that exposes the grilling surface 13 such as shown in FIG. 2b. In FIG. 2b, food items 14 comprised of steaks are positioned on the grilling surface 13 underneath the frame 30 while food items 14 comprised of hot dogs are positioned on the rollers 40.

To swing the frame 30 between its at least two positions, the pivot handle 38 may be grasped and pulled upwardly to allow rotation of the frame 30 around the pivot connectors 29, 33. In the exemplary figures such as shown in FIGS. 2a, 2b, and 6, the frame 30 will rotate with respect to the base 20 around the pivot connectors 29, 33.

The frame 30 may be swung or rotated between a first position which covers the grilling surface 13 and a second position which exposes the grilling surface 13. When the frame 30 is in its first position, the frame 30 may rest upon and be supported by the ledge 28 of the base 20.

The frame 30 will preferably be in an elevated position with respect to the grilling surface 13 so that there is space underneath the frame 30 for a food item 14 to be cooked underneath the rollers 40 when the frame 30 is in its first position. The frame 30 may be freely swung, rotated, or pivoted between its various positions to expose the underlying grilling surface 13 as needed. The height at which the frame 30 is elevated from the grilling surface 13 may vary in different embodiments. In some embodiments as described herein, the elevation may be adjusted by the operator. The desirable elevation of the frame 30 with respect to the grilling surface 13 will vary depending on the food item 14 being cooked on the grilling surface 13.

The rollers 40 may be rotated to evenly apply heat around cylindrical food items 14 such as hot dogs. The food items 14 are first positioned on or between the rollers 40. The rollers 40 may be rotated automatically in embodiments utilizing the first rotator assembly 50 of FIGS. 1-12 or manually in embodiments utilizing the second rotator assembly 60 of FIGS. 13-22.

With respect to the first rotator assembly 50, the motor 55 may be activated to rotate its drive shaft which directly rotates the central rotator gear 53. A linkage 54 such as a chain is connected around the central rotator gear 53 and two outer rotator gears 51, 52 such that the chain traverses a loop when the motor 55 is operating. The roller gears 45 are interlinked with the linkage 54 such that the roller gears 45 and respective rollers 40 are rotated as the linkage 54 traverses its loop.

With respect to the second rotator assembly 60, the rotator handle 65 may be manually or automatically rotated. As the rotator handle 65 is rotated, the rotator rod 63 rotates as well. The rotator gears 64 on the rotator rod 63 are thus rotated along with the rotator rod 63, which causes the rollers 40 themselves to rotate.

Unless otherwise defined, all technical and scientific terms used herein have the same meaning as commonly understood by one of ordinary skill in the art to which this invention belongs. Although methods and materials similar to or equivalent to those described herein can be used in the practice or testing of the grill roller system, suitable methods and materials are described above. All publications, patent applications, patents, and other references mentioned herein are incorporated by reference in their entirety to the extent allowed by applicable law and regulations. The grill roller system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A grill roller system, comprising:
a base adapted to be positioned on a grill;
a frame pivotally connected to the base, wherein the frame is adapted to swing between a first position covering a grilling surface and a second position exposing the grilling surface;
a plurality of rollers rotatably connected to the frame for cooking a food item; and
a rotator assembly for rotating the rollers.

2. The grill roller system of claim 1, wherein the frame is vertically adjustable with respect to the base.

3. The grill roller system of claim 1, wherein the frame is elevated above the grilling surface.

4. The grill roller system of claim 1, further comprising a pivot pin connected between the base and the frame, wherein the frame is adapted to pivot around the pivot pin with respect to the base.

5. The grill roller system of claim 1, wherein the rotator assembly comprises a motor for rotating the rollers.

6. The grill roller system of claim 1, wherein the rotator assembly comprises a rotator handle for rotating the rollers.

7. The grill roller system of claim 1, wherein the base is adapted to be connected to the grill.

8. The grill roller system of claim 1, wherein each of the rollers comprises a roller gear.

9. The grill roller system of claim 8 wherein the rotator assembly comprises a motor adapted to traverse a linkage around a loop, wherein the roller gear of each of the rollers is rotated by the linkage as the linkage traverses the loop.

10. The grill roller system of claim 8, wherein the rotator assembly comprises a rotator rod including a plurality of rotator gears.

11. The grill roller system of claim 10, wherein each of the rotator gears is interconnected with one of the roller gears of the rollers such that rotation of the rotator gears imparts rotational force to the roller gears.

12. The grill roller system of claim 10, wherein the roller gear of each of the rollers rotates about a first axis, wherein the rotator gears each rotate about a second axis, wherein the first axis is perpendicular with respect to the second axis.

13. A grill roller system, comprising:
a grill including a grilling surface;
a base connected to the grill;
a frame pivotally connected to the base, wherein the frame is elevated with respect to the grilling surface, wherein the frame is adapted to swing between a first position covering the grilling surface and the second position exposing a grilling surface;
a plurality of rollers rotatably connected to the frame for cooking a food item; and
a rotator assembly for rotating the rollers.

14. The grill roller system of claim 13, wherein the base is height adjustable.

15. The grill roller system of claim 13, further comprising a pivot pin on the base and a pivot receiver on the frame, wherein the pivot pin is positioned within the pivot receiver such that the frame may rotate around the pivot pin.

16. The grill roller system of claim 13, further comprising a pivot handle extending from the frame.

17. The grill roller system of claim 13, wherein the rotator assembly comprises a motor for rotating the rollers.

18. The grill roller system of claim 17, wherein the rotator assembly further comprises a chain adapted to traverse a loop, wherein the chain is adapted to impart rotational force to the rollers as the chain traverses the loop.

19. The grill roller system of claim 13, wherein the rotator assembly comprises a handle for rotating the rollers.

20. The grill roller system of claim 19, wherein the rotator assembly comprises a rotator rod including a plurality of rotator gears, wherein the rotator gears are adapted to impart rotational force to the rollers.
